(19) United States
(12) Patent Application Publication
(10) Pub. No.: US 2007/0152139 A1
(43) Pub. Date: Jul. 5, 2007

(54) Techniques to control illumination for image sensors

(76) Inventor: Mark D. Moores, Beaverton, OR (US)

Correspondence Address: KACVINSKY LLC;C/O INTELLEVATE, P.O. BOX 52050, MINNEAPOLIS, MN, 55402, US

(21) Appl. No.: 11/323,072

(22) Filed: Dec. 30, 2005

(51) Int. Cl. H01J 3/14

(52) U.S. Cl. 250/216

(57) ABSTRACT

Techniques to control illumination for an image sensor are described. An apparatus may include an image sensor having an array of pixels, and a sensor cover to modify an amount of illumination received by at least a subset of the pixels. Other embodiments are described and claimed.

### BACKGROUND

Image sensors are widely used to capture images in devices such as camcorders, digital cameras, smart phones, cellular telephones, and so forth. Image sensors typically comprise an array of pixels. The pixels may operate according to photoelectric principles. In some cases, an amount of illumination received by the pixel array may vary even though illumination from the original scene is relatively uniform. The variations may be due to a number of factors, such as impurities in the optical lens, angle of the optical lens, the shape of the image sensor, and so forth. The variations may result in a captured image that is different from the original scene. This phenomenon is particularly noticeable when the original scene has a uniform or simple background.

### BRIEF DESCRIPTION OF THE DRAWINGS

FIG. 1 illustrates one embodiment of an optical system.

FIG. 2 illustrates one embodiment of an illumination graph.

FIG. 3 illustrates one embodiment of a sensor cover with a first coating.

FIG. 4 illustrates one embodiment of a sensor cover with a second coating.

FIG. 5 illustrates one embodiment of a sensor cover with a third coating.

FIG. 6 illustrates one embodiment of a logic flow.

### DETAILED DESCRIPTION

Various embodiments may be directed to techniques to control illumination for image sensors. In one embodiment, for example, an apparatus may include an optical lens, an image sensor having an array of pixels to receive illumination from the optical lens, and a sensor cover arranged to modify an amount of illumination received by at least a subset of the pixels. In this manner, the apparatus may vary illumination received by portions of the pixel array, thereby ensuring that the entire pixel array receives an amount of illumination similar to the illumination provided by an original scene captured by the apparatus. Other embodiments are described and claimed.

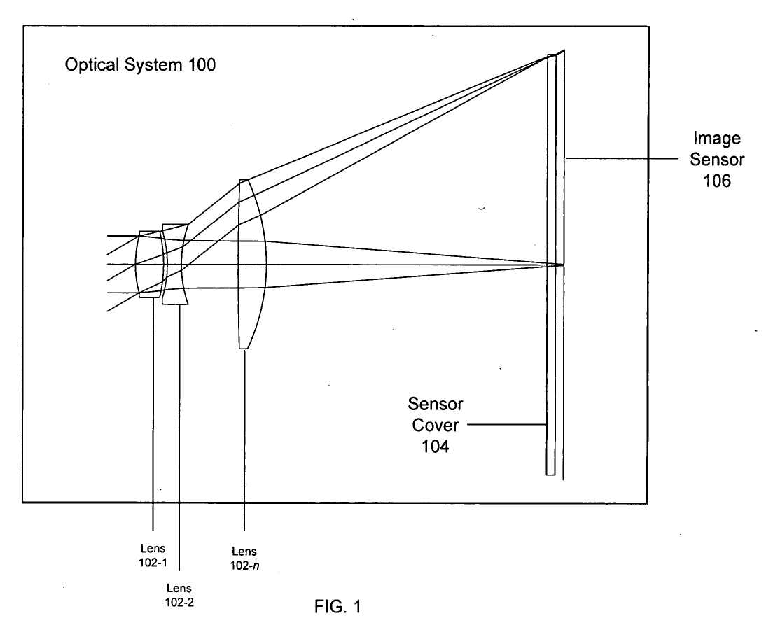

FIG. 1 illustrates one embodiment of an optical system. FIG. 1 illustrates a diagram of an optical system 100. Optical system 100 may be used to capture an electronic image. Optical system 100 may be a component used in any number of devices, such as digital cameras, optical scanners, video cameras, digital camcorders, cellular telephones, smart phones, personal digital assistants (PDA), combination cellular telephones/PDA, processing systems, computer systems, computer sub-systems, computers, appliances, workstations, servers, personal computers, laptops, ultra-laptops, handheld computers, mobile computing devices, handheld devices, wearable computers, telescopes, night vision devices, and similar devices. In one embodiment, for example, optical system 100 may be used generally for digital photography. The embodiments, however, are not limited in this context.

In various embodiments, optical system 100 may include optical lenses 102-1-n, a sensor cover 104, and an image sensor 106. Although optical system 100 is shown in FIG. 1 with a limited number of elements in a certain arrangement by way of example, it can be appreciated that optical system 100 may include more or less elements in other arrangements as desired for a given implementation. Furthermore, optical system 100 may be implemented with various hardware components (e.g., control circuits), software components and/or other suitable components for implementation with a given device. The embodiments are not limited in this context.

In various embodiments, optical system 100 may include optical lenses 102-1-n. As shown in FIG. 1, optical lenses 102-1-n may include three optical lenses arranged in sequence to direct incoming light towards image sensor 106 via sensor cover 104. In one embodiment, for example, optical lenses 102-1-n may be arranged as a wide angle lens system. A wide angle lens system provides for a wide acceptance angle of incoming light from a particular scene. For example, optical lenses 102-1-n may be arranged to direct incoming light up to a 30 degree angle normal to the surface of sensor cover 104 and image sensor 106. Although optical system 100 is shown with three lenses designed to achieve a given angle by way of example, it may be appreciated that more or less lenses may be used in different arrangements to achieve different angles as desired for a given implementation. The embodiments are not limited in this context.

In various embodiments, optical system 100 may include sensor cover 104. Sensor cover 104 may be positioned over image sensor 106 to protect image sensor 106 from damage, such as incurred during manufacturing, assembly or normal use, for example. Sensor cover 104 may comprise any transparent or semi-transparent material that allows light from optical lenses 102-1-n to reach image sensor 106. For example, suitable materials for sensor cover 104 may include various plastics, polymers, polymer blends, silicon, glass, and other similar materials. The embodiments are not limited in this context.

In various embodiments, optical system 100 may include image sensor 106. In one embodiment, for example, image sensor 106 may comprise a charge coupled device (CCD) image sensor. A CCD image sensor may be used for recording images. For example, a CCD image sensor can receive charge via a photoelectric effect to create electronic images.

In one embodiment, image sensor 106 may comprise an integrated circuit containing an array of pixels. Each pixel may capture a portion of the instant light that falls on the pixel array and convert it into an electrical signal. For example, image sensor 106 may be implemented as a complimentary metal oxide semi-conductor (CMOS) image sensor, although the embodiments are not limited in this respect. Each pixel of the image sensor may be formed on a silicon substrate and comprises a photosensitive area such as a photodiode. The pixel may be formed using, for example, photo-lithographic techniques. A color filter may be placed on top of the photosensitive area that allows one primary color (e.g., red, green or blue) to pass through to the photosensitive area. The color filter may be applied to the pixel using existing commercial color filter array (CFA) materials. To increase the photosensitivity of the photosensitive area, a micro-lens may be formed over the photosensitive area and the color filter. The pixel may further comprise other semiconductor devices such as capacitors and transistors which process the electrical signal generated by the photosensitive area. Therefore, generally, the photosensitive area occupies a portion of the overall pixel area.

In general operation, optical system 100 may project an image via optical lenses 102-1-n on the pixel array, causing each capacitor to accumulate an electric charge proportional to the light intensity at that location. A one-dimensional array captures a single slice of the image, and is typically used in line-scan cameras. A two-dimensional array captures the whole image or a rectangular portion of it, and is typically used in video and still cameras. Once the pixel array has been exposed to the image, a control circuit causes each capacitor to transfer its contents to an adjacent capacitor. The last capacitor in the array dumps its charge into an amplifier that converts the charge into a voltage. By repeating this process, the control circuit converts the entire contents of the array to a varying voltage, which it samples, digitizes and stores in memory. Stored images can then be transferred to a printer, storage device or video display.

In various embodiments, image sensor 106 may have relatively high optical sensitivity and a wide acceptance angle of incoming light. A wide acceptance angle may be desirable for both zoom and low profile systems. A wide angle lens system designed to take advantage of the wide acceptance angle, however, typically suffers from one of two noticeable aberrations, referred to as barrel distortion and uneven scene illumination.

Sensitivity of image detector 106 is a function of the angle of incidence of the photons at its front surface. This is caused by the shape of the sensor and also because several different materials are usually used. Optical lenses 102-1-n used to project an image onto image detector 106 also generates illumination that has an angular dependence. Combined, these effects cause the brightness of a detected scene to vary artificially. For example, since the photosensitive area occupies a portion of the pixel, each pixel has an acceptance angle in which the photosensitive area is responsive to the incident light falling on the pixel. Therefore, only incident light that falls up to a certain angle normal to the surface of the pixel will be detected by the light sensitive area of the pixel. This may cause image sensor 106 to have a response that is not the same for all pixels even when a uniform illuminating light has been applied to image sensor 106. For example, under a uniform illumination the readouts obtained from the pixels around the image sensor center may be higher than the readouts near the image sensor periphery. As a result, images may be brighter in the center and darker at the edges. This characteristic may be even more noticeable in the case where the scene has a uniform or simple background.

Various embodiments may solve these and other problems. Various embodiments may be directed to techniques to control illumination for image sensors. In one embodiment, for example, sensor cover 104 may be arranged to modify an amount of illumination received by some or all of the pixels in the pixel array of image sensor 106. For example, sensor cover 104 may direct a greater amount of illumination to some portions of image sensor 106, a lesser amount of illumination to other portions of image sensor 106, or a combination of both. In this manner, sensor cover 104 may vary the amount of illumination directed to particular portions of image sensor 106, thereby ensuring that the entire pixel array of image sensor 106 receives an amount of illumination similar to or matching the illumination provided by the original scene. As a result, optical system 100 may alleviate any perceptual non-uniformity in illumination, thereby improving overall image quality.

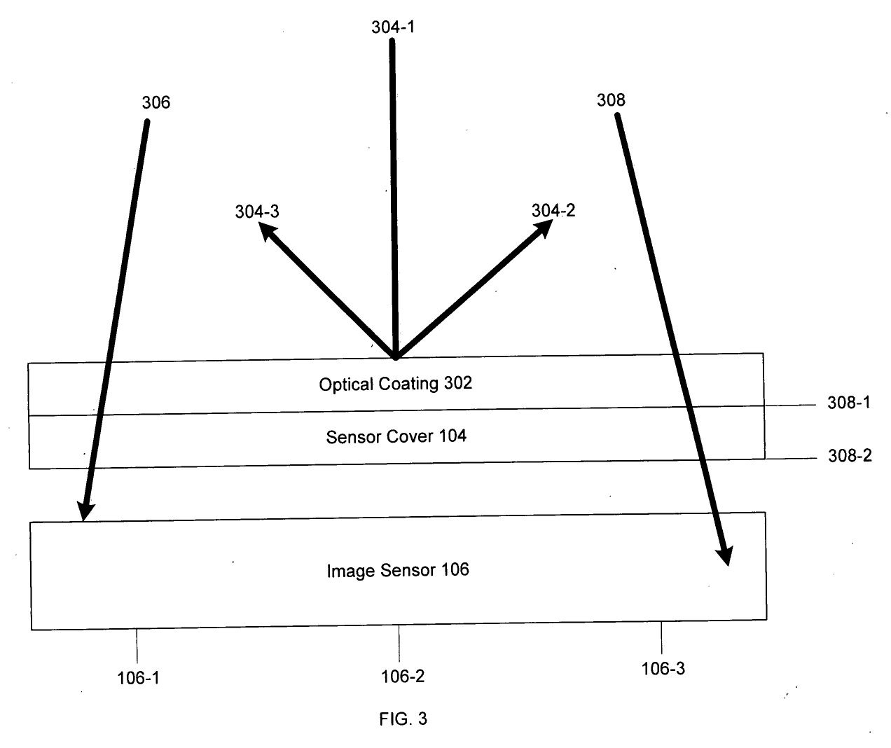

In various embodiments, sensor cover 104 may modify an amount of illumination received by some or all of the pixels in the pixel array of image sensor 106 using a number of different techniques. For example, an optical coating may be applied to sensor cover 104. In another example, an optical coating may be applied directly to image sensor 106. In yet another example, sensor cover 104 may be made of a material providing the same characteristics as an optical coating. Although FIGS. 3-5 may provide various embodiments with sensor cover 104 having an optical coating by way of example only, it may be appreciated that other techniques may be used to modify illumination for image sensor 106 and still fall within the scope of the embodiments. The embodiments are not limited in this context.

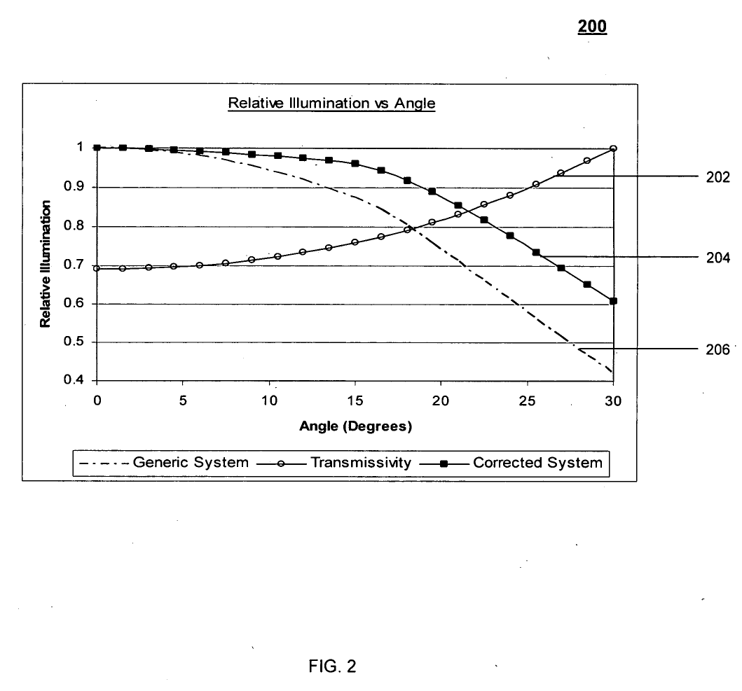

FIG. 2 illustrates one embodiment of an illumination graph. FIG. 2 illustrates an illumination graph 200. Illumination graph 200 may have values representing angle of incidence from a center of image sensor 106 to an edge of image sensor 106 on an x-axis, and values representing relative illumination (RI) on a y-axis. As shown in illumination graph 200, an optical coating on sensor cover 104 having a transmissivity profile as represented by line 202 may be used to correct for the relative illumination effects caused by the optical system as represented by line 206. As shown by line 206, assuming the relative illumination value at the center of image sensor 106 is 1.0 at a 0 degree angle, the relative illumination values decrease as the angle of incidence increases to 30 degrees which occurs when moving towards the edges of image sensor 106. As the transmissivity profile of the optical coating increases, however, the relative illumination values as represented by line 206 may be improved as represented by the corrected values of line 204. For example, if the specified limit to relative illumination were 0.5, the application of the optical coating may potentially transform a failing design (e.g., a minimum RI of 0.42) into a passing design (e.g., a minimum RI of 0.61). The design tradeoff for using the optical coating, however, is that the exposure time may need to be increased by a proportional amount, which in this example may comprise approximately 30%. Accordingly, a particular optical coating should be selected with a view towards a given exposure time as desired for a given implementation.

Various embodiments may achieve the corrective effects of the optical coating as indicated by illumination graph 200 using different types of optical coatings with varying characteristics and implementation techniques. Some embodiments may be further described with reference to FIGS. 3-5.

FIG. 3 illustrates one embodiment of a sensor cover with a first coating. FIG. 3 illustrates sensor cover 104 with a first optical coating 302. Although FIG. 3 illustrates optical coating 302 as disposed on one side (surface 308-1) of sensor cover 104, optical coating 302 may also be disposed on both sides (surfaces 308-1, 308-2) of sensor cover 104 as desired for a given implementation. Optical coating 302 may comprise a material arranged to partially reflect illumination away from a subset of pixels of the pixel array for image sensor 106. For example, optical coating 302 may comprise a reflective material, such as silver, aluminum or some other reflective metal. Optical coating 302 may be applied to sensor cover 104 to achieve partial silvering as a function of radial distance from the optical center of sensor cover 104 and image sensor 106. For example, the partial silvering may be formed in a pattern that provides a greater amount of reflection at a center portion 106-2 of image sensor 106, and a lesser amount or no amount of reflection towards edge portions 106-1, 106-3 of image sensor 106. The partial silvering may therefore reflect incoming light 304-1 from optical lenses 102-1-n away from center portion 106-1 of image sensor 106 causing reflections 304-2, 304-3, thereby making image sensor 106 less sensitive at center portion 106-2. At the same time, the partial silvering may allow incoming light 306, 308 to reach edge portions 106-1, 106-3 of image sensor 106. One advantage of this technique is that it is less complex to implement relative to other techniques. The partial silvering of the optical coating, however, may reflect and scatter incoming light, such as incoming light 306, 308 as reflected off of image sensor 106. This may cause flaring and ghosting that may degrade the overall quality of an image.

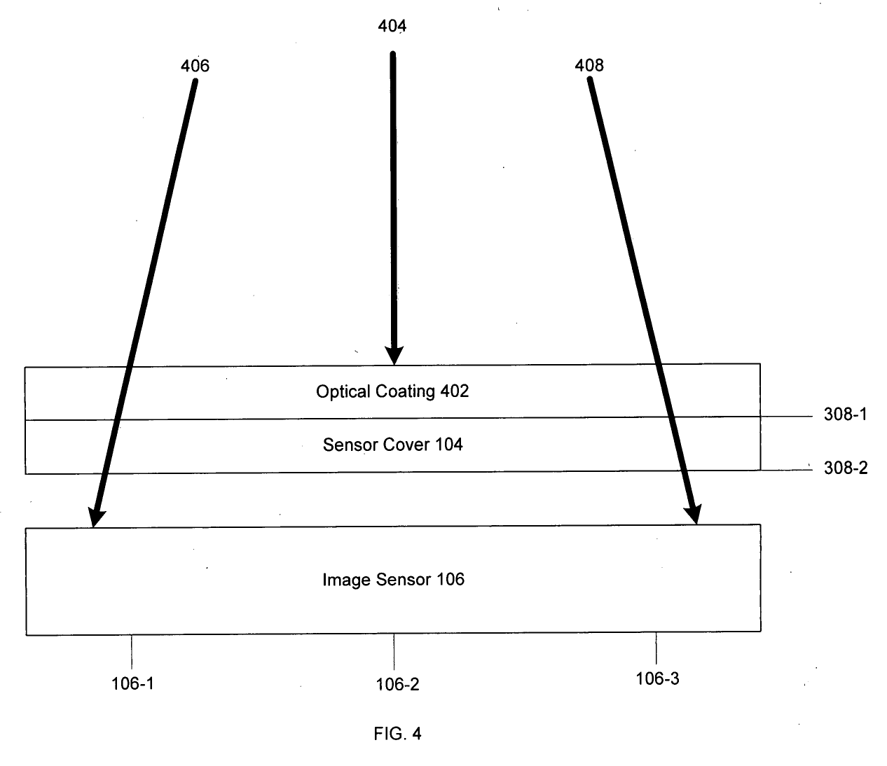

FIG. 4 illustrates one embodiment of a sensor cover with a second coating. FIG. 4 illustrates sensor cover 104 with a second optical coating 402. Although FIG. 4 illustrates optical coating 402 as disposed on one side (surface 308-1) of sensor cover 104, optical coating 402 may also be disposed on both sides (surfaces 308-1, 308-2) of sensor cover 104 as desired for a given implementation. Optical coating 402 may comprise a material arranged to partially absorb illumination directed at a subset of pixels of the pixel array for image sensor 106. For example, optical coating 402 may comprise an absorbing material, such as a dark color (e.g., black) or some other absorbing pigment. This can be achieved by printing a spatially varying microdot pattern of an absorbing “dark” material on sensor cover 104, with the spatially varying microdot pattern having a higher density at center portion 106-2 of image sensor 106, and a lower density at edge portions 106-1, 106-3 of image sensor 106. Resolution of the patterning process would need to be relatively high, with the microdots having a diameter smaller than the diameter for the pixels used for image sensor 106. The partial absorption may therefore absorb incoming light 404 from optical lenses 102-1-n directed towards center portion 106-2 of image sensor 106, thereby making image sensor 106 less sensitive at center portion 106-2. At the same time, the partial absorption may allow incoming light 406, 408 to reach edge portions 106-1, 106-3 of image sensor 106. An absorption profile as a function of position or angle could be tailored to each sensor and optics combination, or a generic profile could be used for “off the shelf” systems. One advantage of this technique relative to optical coating 302 is that it does not reflect light, and therefore should not reduce image quality.

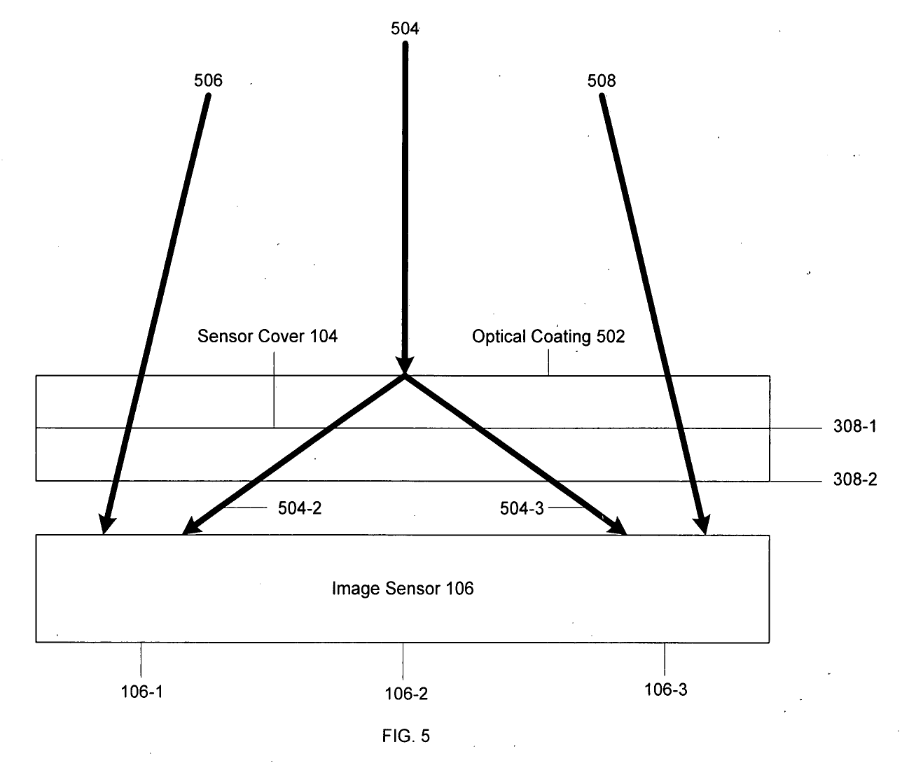

FIG. 5 illustrates one embodiment of a sensor cover with a third coating. FIG. 5 illustrates one embodiment of a sensor cover with a third coating. FIG. 5 illustrates sensor cover 104 with a third optical coating 502. Although FIG. 5 illustrates optical coating 502 as disposed on one side (surface 308-1) of sensor cover 104, optical coating 502 may also be disposed on both sides (surfaces 308-1, 308-2) of sensor cover 104 as desired for a given implementation. Optical coating 502 may comprise a material arranged to partially redirect or reflect illumination towards a subset of pixels of the pixel array for image sensor 106. For example, optical coating 502 may have a controlled transmission and/or reflection characteristic as a function of angle. Optical coating 502 may have a dielectric stack design that redirects incoming light away from center portion 106-2 of image sensor 106 and towards edge portions 106-1, 106-3 of image sensor 106. For example, redirecting incoming light 504-1 from optical lenses 102-1-n away from center portion 106-1 of image sensor 106 may make image sensor 106 less sensitive at center portion 106-2. At the same time, the redirected light 504-2, 504-3 may reach edge portions 106-1, 106-3, respectively, of image sensor 106. The redirected light 504-2, 504-3 combined with incoming light 506, 508 may make pixels located at edge portions 106-1, 106-3 more sensitive to light. Potential disadvantages of this technique are that wavelength dependent transmission and reflections might generate strange colors, and reflections might also degrade image quality.

In the above described embodiments, sensor cover 104 is described as having various optical coatings, such as first optical coating 302, second optical coating 402, or third optical coating 502. In other embodiments, sensor cover 104 may be made of a material that provides the same advantages and characteristics of the various optical coatings, rather than applying the various optical coatings after sensor cover 104 has been made. For example, sensor cover 104 may be made of a material with a spatially varying absorption profile similar to the one described with reference to second optical coating 402 and FIG. 4. Similar materials may be used for optical coatings 302, 502. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

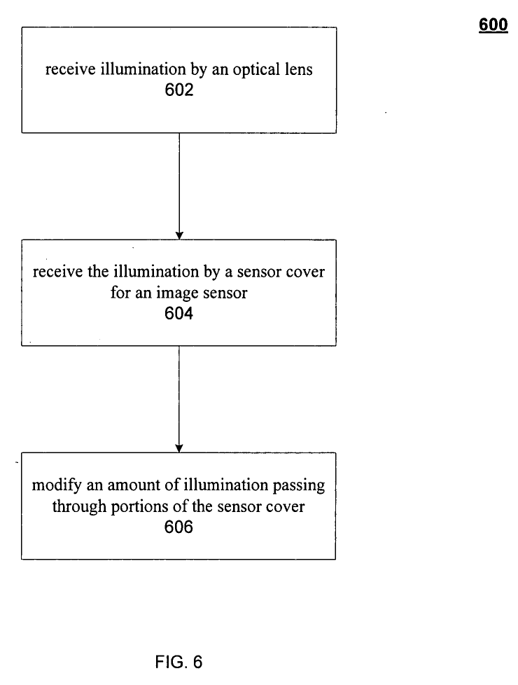

FIG. 6 illustrates one embodiment of a logic flow. FIG. 6 illustrates a logic flow 600. Logic flow 600 may be representative of the operations executed by one or more embodiments described herein, such as optical system 100, sensor cover 104 and/or image sensor 106. As shown in logic flow 600, illumination may be received by an optical lens at block 602. The illumination may be received by a sensor cover for an image sensor at block 604. An amount of illumination passing through portions of the sensor cover may be modified at block 606. The embodiments are not limited in this context.

An amount of illumination passing through portions of the sensor cover may be modified using several different techniques. In one embodiment, for example, an amount of illumination may be reflected away from portions of the sensor cover. In one embodiment, for example, an amount of illumination may be absorbed by portions of the sensor cover. In one embodiment, for example, an amount of illumination may be redirected through portions of the sensor cover. The amount of illumination may be received by a subset of pixels from an array of pixels. In this manner, varying amounts of illumination may be received by an array of pixels. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments. 100301 Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
an image sensor having an array of pixels; and
a sensor cover arranged to modify an amount of illumination received by at least a subset of said pixels.

2. The apparatus of claim 1, said sensor cover to have an optical coating to modify said amount of illumination received by said pixels.

3. The apparatus of claim 1, said sensor cover to partially reflect said illumination away from said subset of pixels.

4. The apparatus of claim 1, said sensor cover to partially absorb said illumination.

5. The apparatus of claim 1, said sensor cover to partially redirect said illumination towards said subset of pixels.

6. The apparatus of claim 1, said sensor cover to provide varying amounts of illumination to said array of pixels.

7. The apparatus of claim 1, said pixels to each have a photosensitive area.

8. A system, comprising:
an optical lens;
an image sensor having an array of pixels to receive illumination from said optical lens; and
a sensor cover to modify an amount of illumination received by at least a subset of said pixels.

9. The system of claim 8, said sensor cover to have an optical coating to modify said amount of illumination received by said pixels.

10. The system of claim 8, said sensor cover to partially reflect said illumination away from said subset of pixels.

11. The system of claim 8, said sensor cover to partially absorb said illumination.

12. The system of claim 8, said sensor cover to partially redirect said illumination towards said subset of pixels.

13. The system of claim 8, said sensor cover to provide varying amounts of illumination to said array of pixels.

14. The system of claim 8, said pixels to each have a photosensitive area.

15. A method, comprising:
receiving illumination by an optical lens;
receiving said illumination by a sensor cover for an image sensor; and
modifying an amount of illumination passing through portions of said sensor cover.

16. The method of claim 15, comprising reflecting said amount of illumination away from portions of said sensor cover.

17. The method of claim 15, comprising absorbing said amount of illumination by portions of said sensor cover.

18. The method of claim 15, comprising redirecting said amount of illumination through portions of said sensor cover.

19. The method of claim 15, comprising receiving said amount of illumination by a subset of pixels from an array of pixels.

20. The method of claim 15, comprising receiving varying amounts of illumination by an array of pixels.
